(19) United States
(12) Patent Application Publication
(10) Pub. No.: US 2009/0039075 A1
(43) Pub. Date: Feb. 12, 2009

(54) Heat element for maintaining laminator at predetermined working temperature

(75) Inventor: T.C. Wang, SanChung City (TW)

Correspondence Address: BACON & THOMAS, PLLC, 625 SLATERS LANE, FOURTH FLOOR, ALEXANDRIA, VA, 22314-1176, US

(73) Assignee: Michilin Prosperity Co., Ltd, SanChung City (TW)

(21) Appl. No.: 11/890,481

(22) Filed: Aug. 7, 2007

(51) Int. Cl. H05B 3/10

(52) U.S. Cl. 219/553; 219/478; 219/539

(57) ABSTRACT

A heating element that can maintain a laminator at a predetermined working temperature is disclosed. A low-power heating filaments and a high-power heating filaments are sandwiched between insulators. The high-power heating filaments are shut down once it is heated to a predetermined temperature. The low-power heating filaments are then turned on to maintain a constant temperature. When the temperature drops below a predetermined temperature, the low-power heating filaments are shut down and the high-power heating filaments are turned on to heat up the laminator. The temperature is thus maintained within a predetermined range through such cycles.

### BACKGROUND OF THE INVENTION

1. Field of Invention

The invention relates to a laminator and, in particular, to a heating element that can maintain the laminator at a predetermined working temperature.

2. Related Art

As is well known, the laminator is used to protect important documents such as photos and identifications. The laminated product is first inserted into a film. The heating element of the laminator radiates heat to pressing rollers. The film and the laminated product are pressed by the high-temperature pressing rollers and combined together.

In the above-mentioned laminating process, two problems that are complained the most by users are long pre-heating time and inhomogeneous pressing roller temperature. The inhomogeneous pressing roller temperature results in bad laminating quality. A pre-heating time longer than five minutes makes users impatient.

### SUMMARY OF THE INVENTION

An objective of the invention is to provide a heating element that can maintain the laminator at a predetermined working temperature. By reducing the pre-heating time, the user can operate the laminator within the shortest possible time.

Another objective of the invention is to provide a heating element that can maintain the laminator at a predetermined working temperature. By providing a homogeneous pressing roller temperature, the user can obtain better laminating quality and avoid foggy bubbles due to low temperatures or burning due to high temperatures.

To achieve the above objectives and solve the problems in the prior art, the invention provides a heating element that can maintain a laminator at a predetermined working temperature. Low-power and high-power heating filaments are sandwiched between insulating materials. The high-power filaments are shut down once it is heated to a predetermined temperature. The low-power heating filaments take over to maintain the temperature. When the temperature drops below a predetermined temperature, it is shut down and the high-power heating filaments are turned on to re-heat the laminator. The temperature is thus maintained within a predetermined range through such cycles.

### BRIEF DESCRIPTION OF THE DRAWINGS

The invention will become more fully understood from the detailed description given herein below illustration only, and thus is not limitative of the present invention, and wherein:

FIG. 1 is an exploded three-dimensional view of the laminator heating element according to the first embodiment of the invention; and

FIG. 2 is an exploded three-dimensional view of the laminator heating element according to the second embodiment of the invention.

### DETAILED DESCRIPTION OF THE INVENTION

The present invention will be apparent from the following detailed description, which proceeds with reference to the accompanying drawings, wherein the same references relate to the same elements.

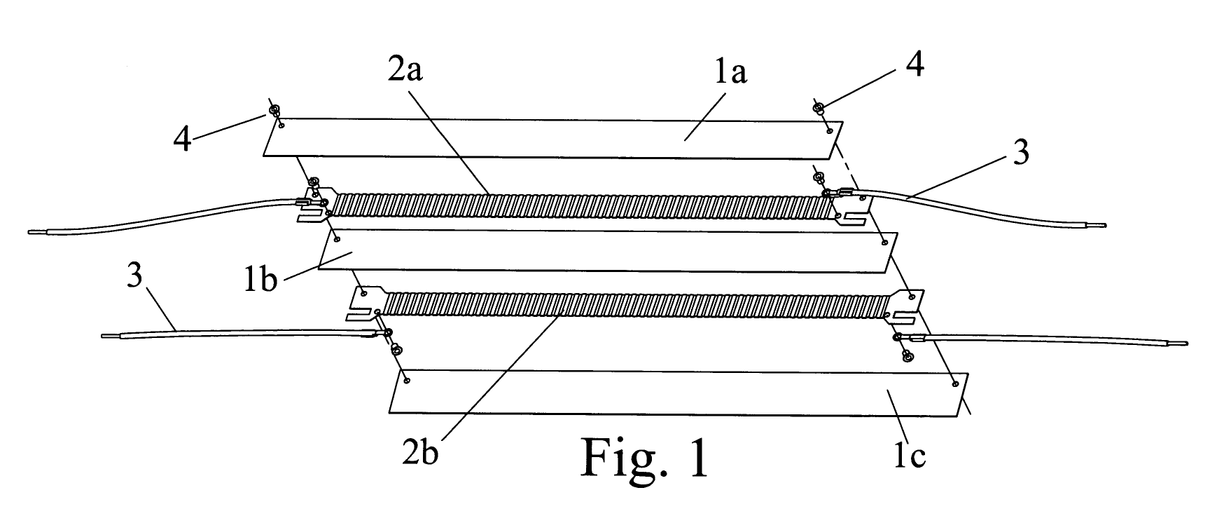

Please refer to FIG. 1, which shows the exploded three-dimensional structure of the disclosed heating element according to the first embodiment. The heating element includes top, middle, and bottom insulating materials such as mica sheets 1a, 1b, 1c and low-power heating filaments 2a and high-power heating filaments 2b arranged into a stripe shape and sandwiched between the mica sheets 1a, 1b, 1c. Both ends of the low-power heating filaments 2a and the high-power heating filaments 2b are connected with a power supply (not shown) via wires 3. The above-mentioned elements are fixed using, for example, rivets.

In practice, the high-power heating filaments 2b are shut down once it is heated to a predetermined high temperature. In this case, the low-power heating filaments 2a are turned on to maintain the laminator at a constant temperature for lamination. If the laminating temperature drops below a predetermined low temperature, the low-power heating filaments 2a are turned off, and the high-power heating filaments 2b are turned on to re-heat to the required working temperature. The temperature is thus maintained within a predetermined range of the working temperature through such cycles. Therefore, the invention can avoid the production of foggy bubbles due to low temperatures or wavy folding due to high temperatures.

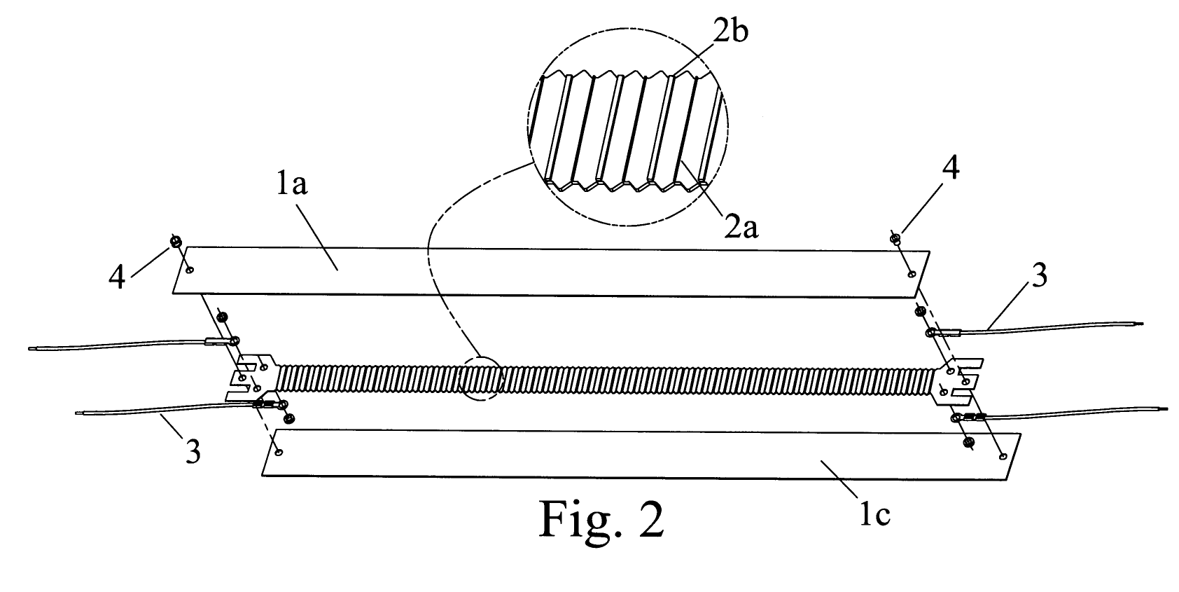

FIG. 2 is an exploded three-dimensional view of the disclosed heating element for a laminator according to the second embodiment. The different between the current embodiment and the previous one is that the low-power heating filaments 2a and the high-power heating filaments 2b are disposed in an alternating way and sandwiched between top and bottom insulating materials 1a, 1c, such as two mica sheets.

As shown by the locally enlarged view, the thicker high-power heating filaments 2b and the thinner low-power heating filaments 2a are disposed alternately. When the high-power heating filaments 2b are heated to a predetermined high temperature, their power is shut down. The low-power heating filaments 2a are then turned on to maintain the temperature. When the temperature is lower than a predetermined low temperature, the low-power heating filaments 2a are turned off, and the high-power heating filaments 2b are turned on to re-heat to the required working temperature. The temperature is thus maintained within a predetermined range of the working temperature through such cycles.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A heating element for maintaining a laminator at a predetermined working temperature, comprising low-power heating filaments and high-power heating filaments sandwiched between insulating materials; wherein the high-power heating filaments are turned off once it is heated to the predetermined working temperature and the low-power heating filaments are turned on to maintain the temperature, whereas the low-power heating filaments are turned off once the temperature drops low and the high-power heating filaments are turned on for re-heating.

2. The heating element for maintaining a laminator at a predetermined working temperature as in claim 1, wherein the insulating materials are at least two mica sheets.

3. The heating element for maintaining a laminator at a predetermined working temperature as in claim 1, wherein the high-power heating filament is a thick heating filament.

4. The heating element for maintaining a laminator at a predetermined working temperature as in claim 1, wherein the low-power heating filament is a thin heating filament.
